(19) United States
(12) Patent Application Publication
(10) Pub. No.: US 2007/0157445 A1
(43) Pub. Date: Jul. 12, 2007

(54) Drive-lock cleat setter tool

(76) Inventors: Leonard G. Marlow JR., Chino Valley, AZ (US); William Owens, Chino Valley, AZ (US)

Correspondence Address: Charles R. Sutton, P.O. Box 28044, Prescott Valley, AZ, 86312, US

(21) Appl. No.: 11/710,176

(22) Filed: Feb. 23, 2007

Related U.S. Application Data
(63) Continuation of application No. 11/108,632, filed on Apr. 18, 2005.

(51) Int. Cl. B25B 27/14

(52) U.S. Cl. 29/275

(57) ABSTRACT

A compact, easy-to-use, hand tool which is made for the use of installing “Drive-Lock Cleats” on Heating and Air Conditioning sheet metal ductwork utilizing the “S-Lock and Drive-Lock” assembly system. More precisely the hand tool is used to hold the “Drive-Lock Cleat” steady, preventing damage to the Cleat while the Cleat is being driven into place. Further, the tool is used as a guide to tell the user that the Cleat is installed to the proper depth.

This application claims the benefit of the filing date (under 35 U.S.C. §121) of application Ser. No. 11/108,632 filed on Apr. 18, 2005. That application is currently pending and has been assigned to art unit 3723. That application is the parent application of this divisional application.

### REFERENCES

No references were found in patent searches.

### FIELD OF THE INVENTION

This invention relates to a hand tool used for setting Drive-Lock cleats used to attach two sections of sheet metal ductwork comprising of “S and Drive” assembly systems.

### BACKGROUND OF THE INVENTION

Rectangular Heating and Air Conditioning ductwork is assembled or attached together to form a chain of ductwork to deliver conditioned air from an Air Handler or Furnace to specific points in a building or dwelling. The Ductwork is assembled by one of two means known widely in the art. The first means is by the use of S-Lock, and Drive-Lock cleats. The second means incorporates the use of flanges, known widely in the art as “Ductmate”, “TDC”, or “TDF, which will not be the subject of this invention. The S-lock and Drive-lock cleats assembly methods involve the use of S-Lock, which is a cleat that is formed in a flat “S” shape, so that the S-Lock may be placed on the flat edge of two separate sections of rectangular ductwork. The second portion of this method requires the use of Drive-Lock cleats, which are formed from a narrow flat strip of sheet metal. The flat strip is then folded approximately ½″ on each longitudinal side, both folds being folded in the same direction toward each other, leaving approximately ¼″ between the folded edges. The drive-Lock then slips over like folded edges, each fold being folded out away from the ductwork, and then folded back against the ductwork, on each side of the ductwork perpendicular to the flat edges of the ductwork containing the S-Lock. In many instances, when the flat edges of the ductwork is folded over, the folded edges will be compressed against the ductwork. This will require the use of the flat edge of a screwdriver, or some other flat edge material, to open the leading edge of the folded portion of the ductwork. Opening the leading edges allows the user to place or start the Drive-Lock cleat. The Drive Lock Cleat is then driven onto the folded edges of the two sections of ductwork until the cleat encompasses the entire side of the ductwork with a portion of the cleat extending at least 1″ beyond the edges of the ductwork. The extended sections of the Drive-Lock cleat are then driven over the edges of the ductwork against the S-Lock cleat, locking the sections of ductwork in place. Current means of driving the Drive-Lock cleat incorporates the use of a hammer, or some other relatively massive tool. In many instances while driving the Drive-Lock cleat onto the ductwork, the Drive-Lock cleat is damaged on the ends being hammered causing a term known in the art as “mushrooming” and may render the Drive-Lock cleat unusable.

### SUMMARY OF THE INVENTION

The hand tool of the present invention is an inexpensive, easy-to-use hand tool, which can be used to hold a Drive-Lock cleat while the cleat is being driven into place.

The hand tool of the present invention comprises a handle of relatively flat stock with beveled edges on one end of the handle. The beveled edge may be used to replace the use of a separate screwdriver for opening the leading edge of the formed flat section on the ductwork, allowing the operator to start the Drive-Lock Cleat.

On the other end of the hand tool is a slotted section, which holds one end of the Drive-Lock cleat while the outer portion of the hand tool is absorbing the hammer blows.

The configuration of the hand tool makes it easy to use as both an aide while driving the Drive-Lock cleat into place, as well as an aide in opening the leading edge of the folded flat section of the ductwork. The depth of the slotted portion of the hand tool provides the desired length of the cleat extension on both edges of the ductwork for locking the cleat on the ductwork

### BRIEF DESCIPTION OF THIE DRAWINGS

FIG. 1 is cross-sectional view showing the relationship of the handle, a block with a slotted portion, the impact anvil, and drive opener.

FIG. 2 is frontal view of the hand tool showing the configuration of the handle, the drive opener, and the slotted portion. The impact anvil is hidden on the backside of the hand tool.

### DESCRIPTION OF THE PREFERRED EMBODIMENT

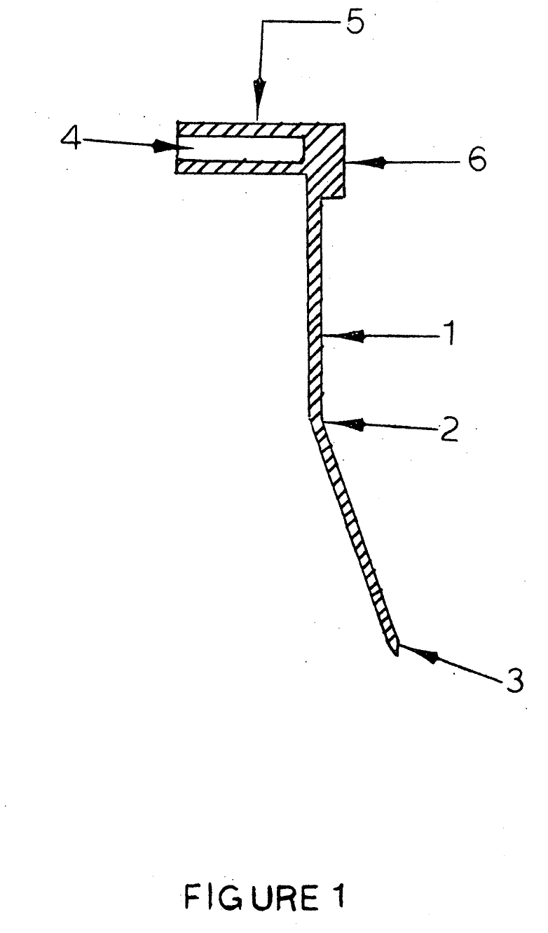

Referring to FIG. 1, a preferred embodiment of the hand tool of the present invention comprising a handle (1), which is preferably made from flat stock, suitable for a comfortable grip by a human hand, with a slight bend (2) which bends upward away from a parallel axis of the initial length of the handle (1). Because a hammer or some other relatively massive tool will be used to strike blows on the impact anvil (6), the slight bend (2) in the handle should be of sufficient height to allow the user to grip the handle in a safe and comfortable manner. On one end of the handle (1) is a beveled edge (3), which is preferably beveled in a taper from the edge of the full width of the handle, to a narrow section of the middle edge of the handle. The narrow edge on the end of the handle(1) is then sharpened enough to be comfortably inserted between the two layers of the ductwork. The beveled edge (3) may be of any shape and width suitable for insertion under the folded edges of the ductwork.

Still referring to FIG. 1, on the opposite end of the handle (1), is a block (5), within the block (5) is a slotted portion (4). The block (5) of the present invention is preferably closed on all sides of the slotted portion (4). The slotted portion is of such size as to slip comfortably over a pre-manufactured Drive-Lock cleat without allowing the slotted portion to deviate from side to side and reduce vibration of the Drive-Lock cleat being installed. The preferred depth of the slotted portion (4) is approximately one inch, which is known in the art as the desired length of the Drive-Lock cleat to extend beyond the edges of the ductwork being assembled. The block (5) and slotted portion (4) are preferably perpendicular to the handle (1). Opposite the block (5) and slotted portion (4), and perpendicular to the handle (1) is an impact anvil (6). The preferred configuration of the impact anvil (6) is a solid section of metal extending perpendicular from the handle (1) approximately one half inch. The size and shape of the impact anvil can be any size or shape suitable for receiving a striking blow, from a hammer or some other massive tool, without distortion to the impact anvil (6).

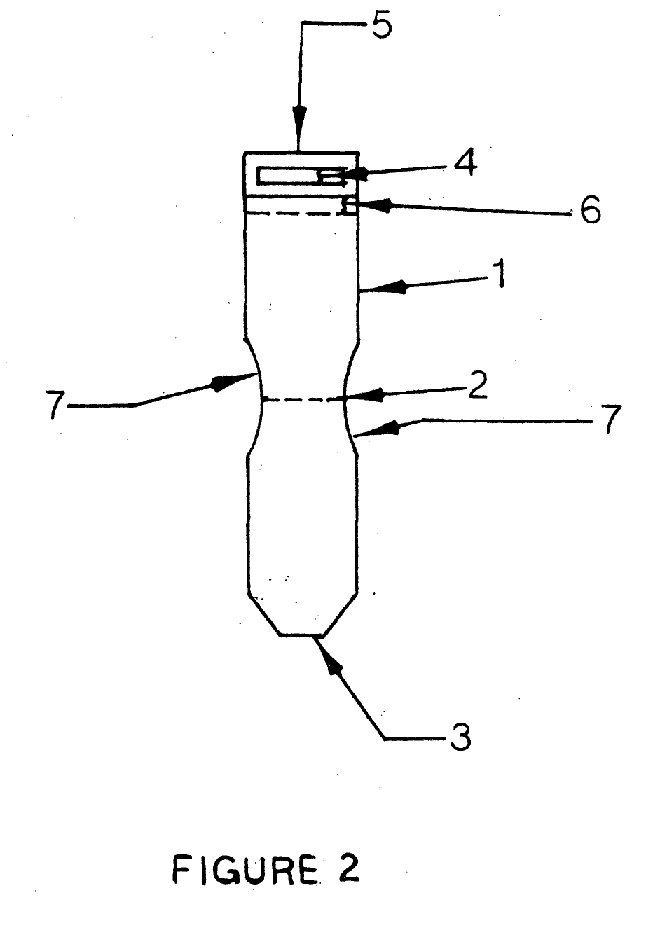

Referring to FIG. 2, a preferred embodiment of the present invention shows a frontal view of the handle (1), the beveled edge (3), the slotted portion (4), the block (5), and the impact anvil (6) on the opposite side of the handle (1) from the Block (5) and slotted portion (4). Further, FIG. 2 indicates a radius portion (7) on both sides of the handle (1). The radius portion (7) of the handle of the present invention is designed to achieve comfort for the user, and is used to locate the center of the slight bend (2). What is claimed:

1. A drive-lock cleat setting hand tool comprising a handle having a longitudinal axis, a convex side, a concave side, a first end, and a second end, said longitudinal axis being bent to an obtuse angle at a point between said first end and said second end, said handle having a block, and an impact anvil attached to said first end, said block being attached to said first end on said convex side and having walls which define a mouth, said anvil being attached to said first end on said concave side, said second end tapering to form a thin edge

2. A drive-lock cleat setting tool of claim 1, wherein the said handle is substantially flat and of such size and shape as to obtain a firm and comfortable grip by a human hand.

3. A drive-lock cleat setting tool of claim 2, wherein said handle has a slight bend upward away from the longitudinal axis suitable to protect the users hands from striking ductwork while the drive-lock cleat is being installed on the ductwork.

4. A drive-lock cleat setting tool of claim 1, wherein said impact anvil is a solid section of steel, used to receive a striking blow from a hammer.

5. The drive-lock cleat setting tool of claim 4, wherein the said impact anvil is a relatively flat surface.

6. A drive-lock cleat setting tool of claim 1, wherein said mouth is substantially one inch in depth.

7. (canceled)

8. (canceled)

9. A drive-lock cleat setting tool of claim 6, wherein the mouth is of such size and shape as to hold a drive-lock cleat in a substantially stationary fashion while the drive-lock cleat is being installed on ductwork.
